(19) United States
(12) Patent Application Publication
(10) Pub. No.: US 2025/0369479 A1
(43) Pub. Date: Dec. 4, 2025

(54) COMPOSITE MATERIAL ROLLING-ELEMENT BEARING CAGE AND ASSOCIATED ROLLING-ELEMENT BEARING UNIT

(71) Applicants: AKTIEBOLAGET SKF, GOTEBORG (SE); SKF Aerospace France S.A.S, Perrigny (FR)

(72) Inventors: Thomas Bernd KRAUSE, Grafenrheinfeld (DE); Valentin Roger Claude FLEURY, Romans-sur-Isère (FR); Feliciano GRECO, Cortemilia (IT); Federico DAL ZILIO, None (IT)

(21) Appl. No.: 19/211,371

(22) Filed: May 19, 2025

(30) Foreign Application Priority Data
May 29, 2024 (IT) 102024000012271

(51) Int. Cl. F16C 33/44

(52) U.S. Cl. CPC F16C 33/44

(57) ABSTRACT

A composite material rolling-element bearing cage includes a plurality of pockets each configured to freely house a rolling element body. The cage is made of a fiber-reinforced synthetic plastic material including a plurality of superimposed layers of reinforcing fibers embedded in a synthetic plastic material. At least one first line tangent to a circumference of a first one of the plurality of pockets and to a circumference of an immediately adjacent second one of the plurality of pockets forms a first acute angle relative to the axis of symmetry, and all the reinforcing fibers of a radially innermost layer of the plurality of superimposed layers and/or a radially outermost layer of the plurality of superimposed layers form a second acute angle with the axis of symmetry, the second angle being less than or equal to the first angle.

### CROSS-REFERENCE

This application claims priority to Italian patent application no. 102024000012271 filed on May 29, 2024, the contents of which are fully incorporated herein by reference.

### TECHNOLOGICAL FIELD

The present disclosure relates to a rolling-element bearing cage formed from a fiber reinforced composite synthetic plastic material as well as to a rolling-element bearing unit, including such a cage.

### BACKGROUND

As it is well known, a rolling-element bearing unit comprises a rolling-element bearing having an outer ring, an inner ring and a plurality of rolling bodies (for example balls) interposed between the inner and outer rings to make them relatively rotatable with low friction, and a rolling-element bearing cage to retain the rolling bodies in position, the cage being arranged in the radial space delimited between the inner ring and the outer ring.

A rolling-element bearing retaining cage comprises an annular body delimited between radially inner and an outer cylindrical surfaces thereof and a plurality of pockets or seats, each configured to house and retain in a freely rotatable manner a respective rolling body of the rolling-element bearing. The cage body may be made of a synthetic plastic material, for example a phenolic resin or any other high performance synthetic material, e.g., epoxy resins, and the pockets or seats are provided radially therethrough, e.g. the pockets are radial through openings.

To improve performance, the synthetic plastic material may be reinforced with fibers of high tensile strength and stiffness, e.g. carbon fibers, glass fibers or any other fibers of similar strength and stiffness. This is generally obtained by laying-up several fiber-reinforced polymeric tape layers in different orientations to reach the desired level of performance.

A preferred method for obtaining fiber reinforced polymeric cages comprises the step of producing a preform in the shape of a hollow tube and the step of cutting the preform tube in a radial direction to obtain a plurality of slices or axial segments of the preform tube, each one cut with a length identical to the axial width of a cage to be obtained. The pockets or seats are drilled either before or after the cutting operation, e.g. directly through the preform tube or through the slices after they are cut from the tube, so that each cut axial segment of the preform tube comes to constitute a desired cage body.

The preform tube may be produced by laying-up several fiber reinforced polymeric tape layers, as mentioned above, or, preferably, by a process known as “continuous filament winding”, by tightly winding on a metal mandrel one or more filaments of composite material the filaments being continuous fibers impregnated with a synthetic plastic resin, e.g. a continuous carbon fiber impregnated with an epoxy resin.

Here and in the following, “plastic resin” is to be understood to mean either a thermoset or thermoplastic synthetic material, e.g., impregnation of fibers can either be made by a liquid thermoset resin or by a solid thermoplastic powder.

After a prefixed number of superimposed radial layers of pre-impregnated fibers are wound on the mandrel, the preform is cured in a known manner to cause the consolidation of the synthetic material impregnating the fibers into a solid matrix, in which the wound fibers remain embedded to constitute the reinforcing material. Curing may occur as disclosed, e.g., in FR 3053624 A1.

### SUMMARY

A fiber reinforced rolling-element bearing cage of the above type is disclosed in a pending patent application of the same Applicant, wherein the high strength and stiff reinforcing fibers are impregnated with a synthetic resin material having a glass transition temperature after curing of 120° C. or more.

Especially when such a composite cage body is obtained via CFW methods is possible to configure the preform tube with a sequence of carbon fiber layers oriented with different angles with respect to one another, in order both to prevent the composite preform tube from exhibiting a strong anisotropic behavior and to improve its mechanical properties and, accordingly, the mechanical properties of the final cage body.

However, the cages produced in the manner disclosed above may suffer of the drawback of having at least the outermost and innermost fiber reinforced polymeric layers, either comprising fiber reinforced tape layers or in layers obtained by CFW techniques, to be subject to delamination either during cage operation or even already during machining either the preform tube or the cut axial segments thereof, e.g., when drilling the holes configured to realize the required pockets or seats for housing in use the rolling bodies of a rolling-element bearing.

Delamination may happen, in particular, when the reinforcing fibers in such innermost and outermost layers are oriented at 90° with respect to the axis of symmetry of either the preform tube or the cage body. The delamination problem, even if limited to specific layers of the composite cage body, may impair the performances of the cage in operation and, above all, may cause scraps during the production cycle, so increasing the production costs, since the delamination is located just at the circumferential portions of the cage body separating adjacent pockets or seats from each other.

An aspect of the present disclosure is to overcome the drawbacks discussed above by providing a composite material rolling-element bearing cage having an improved service life and that preserves the mechanical properties of the cage in all use conditions. It is, above all, an aim of the disclosure to provide a composite material rolling-element bearing cage in which the radially inner and outer layers of composite material do not delaminate either during machining or subsequently in operation, even under high rotational speed and high loads.

It is also an aim of the disclosure to provide a high precision rolling-element bearing unit equipped with a composite material cage able to be employed in particularly stressful applications, like those requiring high rotation speeds and/or subjected to high loads.

According to the disclosure, there are provided a composite material rolling-element bearing cage and an associated rolling-element bearing unit, as defined in the appended claims.

### BRIEF DESCRIPTION OF THE DRAWINGS

Further characteristics and advantages of the present disclosure will become clear from the following description of non-limiting examples thereof, carried out with reference to the Figures of the attached drawings, in which:

FIG. 1 is a side elevational view, partly in section, of a rolling-element bearing unit having a bearing cage according to an embodiment of the present disclosure.

FIG. 2 is a perspective view of the bearing cage of FIG. 1.

FIG. 3 is a schematic perspective view of a portion of a preform tube, with partial layers removed for illustrations purposes, mounted on a mandrel from which the retaining cage of FIG. 2 may be obtained.

FIGS. 4A and 4B are schematic plain views of two circumferential portions of the cage of FIG. 2, arranged side by side for comparison.

### DETAILED DESCRIPTION

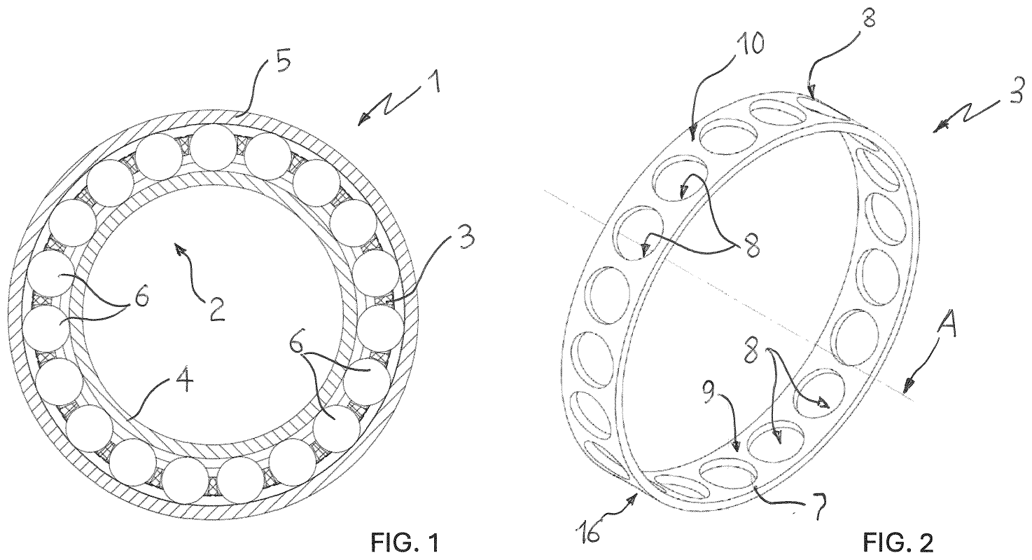

With reference to Figures from 1 to 4, the reference number 1 indicates a rolling-element bearing unit (FIG. 1) comprising a rolling-element bearing 2 of any known type and a rolling-element bearing cage 3 made of a composite material. The rolling-element bearing 2 comprises an inner ring 4, an outer ring 5 and a plurality of rolling elements or bodies 6, in the non-limiting embodiment shown comprising of balls.

The rolling bodies 6 are arranged, in the example shown, in one row of balls around an axis of symmetry A of the rolling-element bearing, which is also the axis of symmetry of cage 3. In different embodiments, not shown for sake of simplicity, the rolling-element bearing 2 may comprise two rows of rolling bodies arranged side by side and the rolling bodies may be without limitation, balls, cylindrical or conical rollers, or small cylinders, according to the operation necessity.

In any case, the rolling-element bearing cage 3 (FIG. 2) comprises an annular body 7 and a plurality of pockets or seats 8, each configured to freely house in use a respective rolling body 6 of the rolling-element bearing 2 to keep the rolling bodies 6 correctly spaced apart from each other by a prefixed pitch (circumferential spacing).

The annular body 7 has an axis of symmetry A and a predetermined axial width or length. The pockets or seats 8 are provided radially throughout the annular body 7, through respective inner and outer cylindrical surfaces 9 and 10 (FIG. 2) of the annular body 7, substantially perpendicularly thereto and, in the example shown, in the form of simple cylindrical radial holes. The cylindrical surfaces 8 and 10 radially delimit the annular body 7 therebetween.

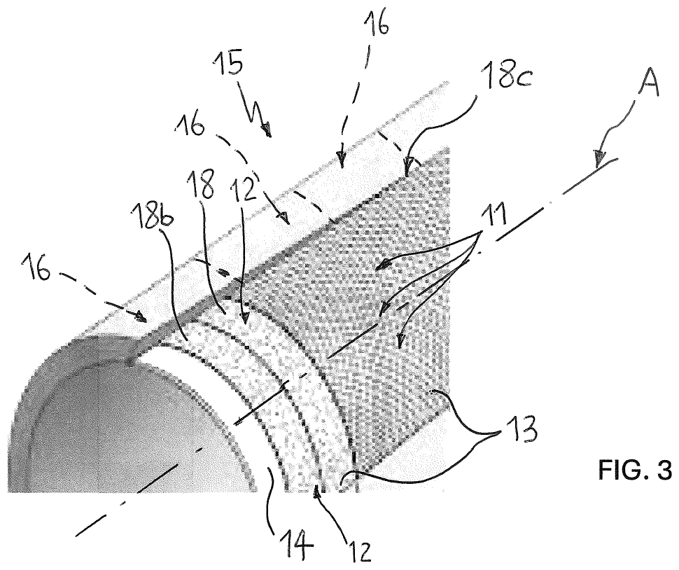

The annular body 7 is made of a fiber-reinforced synthetic plastic material and is preferably obtained by a method known in the art as continuous filament winding. Firstly, according to this method, a preform tube 15 (FIG. 3) is obtaining by winding in a known manner around an axis of symmetry A and on a metal mandrel 14 one or more reinforcing fibers 11 impregnated with a suitable synthetic resin material 13, e.g., carbon fibers impregnated with an epoxy resin, and subsequently cured, e.g. according to FR 3053624 A1, to consolidate the synthetic resin material 13 impregnating the fibers 11 into a solid synthetic plastic material matrix 12 in which fibers 11 are embedded and arranged according to a predetermined pattern. Secondly, selected axial segments 16 of the preform tube 15 are cut radially therefrom, before or after having the pockets or seats 8 drilled therethrough. Accordingly, each segment 16 comes to constitute, after the cutting step, an annular body 7.

In substance, the cage body 7 of the synthetic fiber reinforced rolling-element bearing cage 3 of the disclosure is obtained as an axial portion of the preform tube 15. Each annular body 7, therefore, comprises a plurality of superimposed layers 18 of reinforcing fibers 11 embedded in a synthetic plastic material 13 and arranged with respect to the axis of symmetry A according to prefixed patterns.

In alternative, the preform tube 15 may be obtained using other fabrication methods, e.g. employing superimposed pre-peg tapes or foils of fiber reinforced polymers, in each of which the reinforcing fibers have a selected orientation, resulting in obtaining a preform tube 15 and, accordingly, a plurality of cage bodies 7 detached from the preform tube 15 as axial segments or portion 16 thereof by cutting, formed by superimposed fiber reinforced polymeric tape layers 18.

In some embodiments, the preform tube 15 may be made from either a polymerized fiber reinforced thermoset rein or a polymerized thermoplastic resin. In this latter case, the curing step of the preform tube 15 would be no longer necessary since the thermoplastic powder for impregnating/embedding the fibers needs to be melted (and thus also polymerized) directly on the mandrel 14, e.g., by a laser beam or by a flux of hot air.

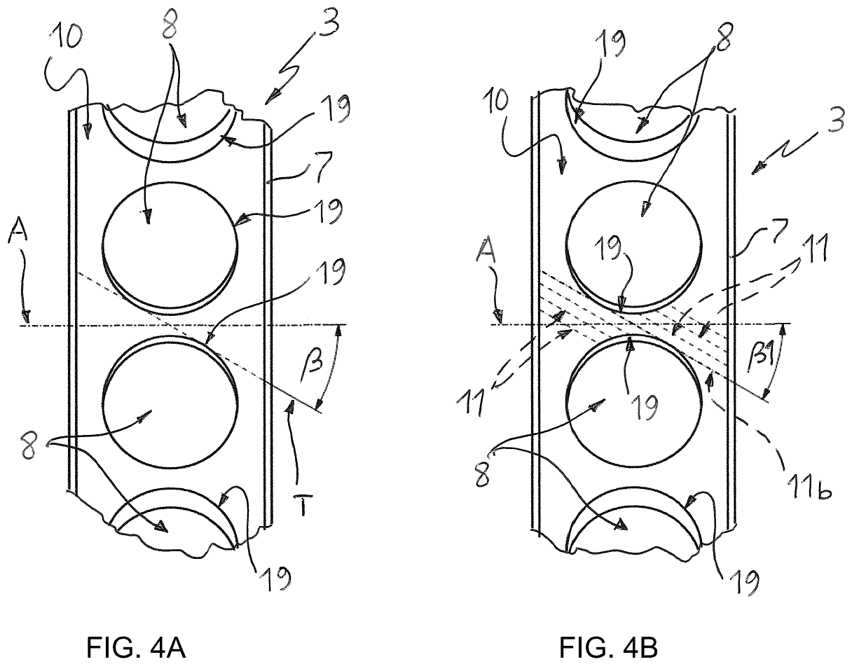

According to a first feature of the disclosure, and irrespective of the method of obtaining the preform tube 15 and of the layers 18, at least one radially inner layer 18 and/or at least one radially outer layer 18 of the superimposed layers of reinforcing fibers 11 are configured to have (FIGS. 4A and 4B) all their fibers 11 oriented such as to form with the axis of symmetry A a first angle β1 less than or substantially identical to a second angle β formed with the axis of symmetry A by a geometric tangent T to both the peripheral edges 19 of any two adjacent pockets or seats 8.

The expression “substantially identical” means that the first angle, due to the working tolerance, may be identical to or different than the second angle by ±3°.

The value of the second angle β is unique and may be easily established in the design stage of the cage 3, when the inner and outer diameter of the cage body 7 and the dimension of the pockets or seats 8 are determined. Therefore, the orientation of the fibers 11 according to an angle β1 are less than or substantially identical to the angle β established in the design stage may be easily obtained by winding in the production stage the fibers 11 around the mandrel 14 according to such angle β1 or using fiber reinforced polymeric tape layers 18 e.g. made of pre-peg material, in which the fibers 11 have been arranged so as to form the angle β1 with the symmetry axis A when the preform tube 15 is formed.

In rolling-element bearing cages 3 designed for high precision bearings the first angle β1 may be generally to be less than or equal to about 34.2°, wherein “about” means a working tolerance of #3°, but, in more general terms, this angle value of 34.2° is valid only for one specific cage size, the angle value depending on the pocket size and number of pockets per cage and cage diameter, and may be easily determined by those skilled in the art.

According to a preferred embodiment, both the at least one radially inner layer 18b and the at least one radially outer layer 18c have their reinforcing fibers 11 oriented according to the first angle β1.

Moreover, the at least one radially inner layer 18 and the at least one radially outer layer 18 having the fibers 11 oriented according to angle β1 are the layers 18b and 18c (FIG. 3) closer to the inner and outer cylindrical surfaces 9 and 10 of the annular cage body 7, e.g., are the radially innermost and outermost layers 18b, 18c of the “packet” of superimposed layers 18 forming the cage body 7.

Such radially innermost and outermost layers 18b, 18c of the superimposed layers 18 forming the cage body 7 accordingly delimit and define the radially inner and outer surfaces 9 and 10, respectively, of the cage body 7.

According to a preferred embodiment, in at least the radially inner layer 18b and the radially outer layer 18c of the plurality of superimposed layers 18, the reinforcing fiber or fibers 11 thereof is/are arranged according to a crisscross configuration, wherein the fiber 11 is/are parallel to each other and arranged at an angle less than or equal to either one or the other of the two geometric tangents T to both peripheral edges 19 of any two adjacent pockets or seats 8.

It is evident that, in fact, that there always exist, geometrically, a pair of tangents T (only one shown in FIG. 4 for sake of simplicity) to both edges 19 of any adjacent pairs of pockets 8 of a rolling-element bearing cage 3, so the fiber 11 may be arranged to form with the axis of symmetry angles less than or substantially equal to the angle formed with the axis of symmetry A by one or both such pair of tangents T, in the latter case by means of a crisscross configuration. Accordingly, the angle β1 may assume either a positive or negative value, assuming 0° represents the orientation of the axis of symmetry A.

In a preferred embodiment, the synthetic resin material 13 forming the solid matrix 12 after curing has a glass transition temperature equal to or greater than 120° C. In a preferred embodiment, the synthetic plastic material 13 consists in an epoxy resin. In a preferred embodiment, the reinforcing fibers 11 are chosen in the group consisting of: carbon fibers, glass fibers, Kevlar® fibers, any synthetic fiber similar thereto for tensile strength and stiffness.

In some embodiments, the reinforcing fibers may consist in mineral fibers like basalt and quartz fibers and also in ceramic fibers, like Al2O3 or SiC fibers and even in metal fibers like steel or aluminum fibers. In some embodiments, the reinforcing fibers may consist in other organic fibers like cotton, cellulose, flax, jute, hemp and sisal fibers.

In a preferred embodiment, the reinforcing fibers 11 are continuous fibers embedded in the synthetic resin 13 and wound around the axis of symmetry A according to prefixed winding angles; such angles which the fibers 11 of each layer 18 form with the axis of symmetry A corresponding to the winding angles thereof.

According to one aspect of the disclosure, finally, the rolling-element bearing unit 1 in FIG. 1 comprises a rolling-element bearing, e.g., the rolling-element bearing 2 or any other model of rolling-element bearing having a plurality of rolling bodies 6 arranged in a radial space delimited between the inner ring 4 and the outer ring 5 to render them relatively rotatable with low friction, and a rolling-element bearing cage 3 as described above for retaining the rolling bodies 6 in a spaced-apart manner. The rolling-element bearing 2 is preferably of the high precision bearing type, characterized by high speed and/or high load of operation.

In fact, a rolling-element bearing cage 3 made according to what described above, having care to provide the fibers 11 of at least the innermost and outermost layers 18b and 18c oriented according to the angle β1 substantially identical to the angle β that the tangent T to edges 19 of two adjacent pockets or seats 8 form with the axis of symmetry A surprisingly completely or almost completely avoids the phenomenon of delamination at or close to the lateral surfaces 9 and 10, especially in correspondence with the circumferential portions of the cage body 7 that separate the pockets or seats 8 from one another.

Experimental tests carried out by the Applicant have in fact shown that the fiber 11 orientation of the tape layers 18 on the inner cylindrical surface and on the outer cylindrical surface of the cage 3 are critical to allow the correct machining of the cage pockets 8. A specific fiber orientation of the fibers 11 of the tape layers 18 on the inner and outer cylindrical surfaces of the cage 3, namely at the inner and outer cylindrical surfaces 9 and 10 of the cage body 7, prevents or substantially prevents delamination of the tape layers 18b, 18c during the machining of the cage 3.

In a specific case tested for a cage designed for high precision bearings, the fiber angle β defined by the disclosure had a value of 34.2°. This means that the inner and outer tape layer 18b, 18c of the composite cage 3 as such, or their reinforcing fibers 11 in case of fabrication via CFW technique, have to be oriented with a fiber angle between 0° and 34.2°.

In doing so, the inner and outer layers 18b, 18c are guaranteed to remain continuous in the inter-pocket area, i.e., in the circumferential portion of the cage body 7 comprised between each pair of adjacent pockets or seats 8. This induces a better structural performance in the inter-pocket area. Thus, during machining or in service, the risk of delamination is significantly reduced, or is even completely avoided. All the aims of the disclosure are therefore achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved composite fiber-reinforced bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A composite material rolling-element bearing cage comprising:
an annular body having an axis of symmetry, an axial width, and a plurality of pockets each configured to freely house a respective rolling body of a rolling-element bearing,
wherein the annular body is made of a fiber-reinforced synthetic plastic material comprising a plurality of superimposed layers of reinforcing fibers embedded in a synthetic plastic material, the reinforcing fibers being arranged in a predetermined pattern relative to the axis of symmetry,
wherein at least one first line tangent to a circumference of a first one of the plurality of pockets and to a circumference of an immediately adjacent second one of the plurality of pockets forms a first acute angle relative to the axis of symmetry,
wherein all the reinforcing fibers of a radially innermost layer of the plurality of superimposed layers and/or a radially outermost layer of the plurality of superimposed layers form a second acute angle with the axis of symmetry, and
wherein the second angle is less than or equal to the first angle.

2. The composite material rolling-element bearing cage according to claim 1,
wherein the second angle is identical to the first angle or no more than 3° less than the first angle.

3. The composite material rolling-element bearing cage according to claim 2,
wherein the first angle is less than or equal to 34.2°.

4. The composite material rolling-element bearing cage according to claim 2,
wherein all the reinforcing fibers of the radially innermost layer of the plurality of superimposed layers and the radially outermost layer of the plurality of superimposed layers form the second angle with the axis of symmetry.

5. The composite material rolling-element bearing cage according to claim 4,
wherein the synthetic plastic material after curing has a glass transition temperature greater than or equal to 120° C.

6. The composite material rolling-element bearing cage according to claim 5,
wherein the at least one first line comprises a first first line and a second first line.

7. The composite material rolling-element bearing cage according to claim 5,
wherein the synthetic plastic material comprises an epoxy resin.

8. The composite material rolling-element bearing cage according to claim 4,
wherein the reinforcing fibers are selected from the group consisting of: carbon fibers, glass fibers, Kevlar® fibers, basalt fibers, quartz fibers, Al₂O₃ or SiC fibers, steel fibers, aluminum fibers, cotton fibers, cellulose fibers, flax fibers, jute fibers, hemp fibers and sisal fibers.

9. The composite material rolling-element bearing cage according to claim 8,
wherein the reinforcing fibers are continuous fibers.

10. A rolling-element bearing comprising:
an outer ring,
an inner ring,
a plurality of rolling bodies arranged between the inner ring and the outer ring, and
a rolling-element bearing cage according to claim 2 between the inner ring and the outer ring.

11. A composite material rolling-element bearing cage comprising:
an annular body having an axis of symmetry, an axial width, and a plurality of pockets each configured to freely house a respective rolling body of a rolling-element bearing,
wherein the annular body is made of a fiber-reinforced synthetic plastic material comprising a plurality of superimposed layers of reinforcing fibers embedded in a synthetic plastic material, the reinforcing fibers being arranged in a predetermined pattern relative to the axis of symmetry,
wherein a first line tangent to a circumference of a first one of the plurality of pockets and to a circumference of an immediately adjacent second one of the plurality of pockets forms a first acute angle relative to the axis of symmetry,
wherein a second line tangent to the circumference of the first one of the plurality of pockets and to the circumference of the immediately adjacent second one of the plurality of pockets forms a second acute angle relative to the axis of symmetry,
wherein a first subset of the reinforcing fibers of a radially innermost layer of the plurality of superimposed layers and/or a radially outermost layer of the plurality of superimposed layers form a third angle with the axis of symmetry, the third angle being less than or equal to the first angle, and
wherein a second subset of the reinforcing fibers of the radially innermost layer of the plurality of superimposed layers and/or the radially outermost layer of the plurality of superimposed layers form a fourth angle with the axis of symmetry, the fourth angle being less than or equal to the second angle.

12. The composite material rolling-element bearing cage according to claim 11,
wherein the third angle is identical to the first angle or no more than 3° less than the first angle and the fourth angle is identical to the second angle or no more than 3° less than the second angle.

13. A rolling-element bearing comprising:
an outer ring,
an inner ring,
a plurality of rolling bodies arranged between the inner ring and the outer ring, and
a rolling-element bearing cage according to claim 12 between the inner ring and the outer ring.
